(19) United States
(12) Patent Application Publication
(10) Pub. No.: US 2012/0025985 A1
(43) Pub. Date: Feb. 2, 2012

(54) RFID tracking of patient specimen samples

(76) Inventors: Jarie G. Bolander, San Francisco, CA (US); Forrest Wunderlich, El Granada, CA (US); Daniel Paley, Redwood City, CA (US)

(21) Appl. No.: 13/135,716

(22) Filed: Jul. 12, 2011

Related U.S. Application Data
(63) Continuation of application No. 12/290,534, filed on Oct. 30, 2008, now abandoned.

(51) Int. Cl. G08B 13/14

(52) U.S. Cl. 340/572.1

(57) ABSTRACT

Miniature RFID tags are used in a system for identifying, locating, tracking and inventorying patient specimens pursuant to medical testing. The RFID tags are attached to specimen vessels, and at a point of collection for patient specimens each RFID tag of a vessel is associated with patient and test data, in a collection site database. When a series of vessels are to go to a laboratory, a hand-held device receives all data on the specimens via download from the collection site PC/database. A courier picks up a container with the specimen vessels and delivers it to the laboratory, along with the hand-held device. At the lab a reader reads all specimen tags, and the data stored in the hand-held device is downloaded to a lab processor/database to verify all specimens are present. Location of specimens can be done by reading or powering up different zones, and the hand-held device can have a power node for selectively powering one or several specimen tags for identification or location of specific specimens.

### BACKGROUND OF THE INVENTION

This invention concerns medical laboratory testing and specimen handling, and specifically encompasses the use of miniature RFID tags, usually of the passive type but sometimes of the active type, for tracking, locating, identifying and inventorying patient specimen samples, such as tissue, blood or other fluids.

Conventionally, patient specimen vessels have been identified using labels attached to each specimen vessel, the labels each carrying patient and specimen information and all relevant data, and sometimes bearing a bar code as an identifier, to be linked with a database connected to a bar code reader. Usually specimens are taken at one location and transported to another for analysis and testing. The specimens can become lost, misplaced or de-labeled, and they are generally not accounted for other than at the point of taking the specimen and at the point of testing. Another problem is that even with a sample in the proper location, it is difficult to physically locate a particular sample among a large population of samples.

Previous specimen tracking systems employing RFID tags have had a fundamental limitation on the range in which could be read. In some cases, the range was at most several millimeters, which is far worse than the alternative of bar codes. This limitation did not allow for the reading of specimens in bulk nor did it allow for cost effective locations systems, which is critical for a cost effective sample tracking and location system.

There is a need for a full accounting tracking system for medical specimens, as well as a specimen locating system from the inception of a specimen through transport (if any) and through storage, analysis, and disposal.

### SUMMARY OF THE INVENTION

Pursuant to the invention specimens are tracked and located in a system employing RFID tags, preferably miniaturized RFID tags which may have dimensions less than a few millimeters, these tags being secured directly onto the specimen vessel, such as a blood tube. At a point of collection for patient specimens, an RFID tag is placed on (or has earlier been placed on) each vessel, preferably along with a printed label carrying the name of the patient and other data relative to the collection of the specimen. Each collection site has a computer such as a PC, and preferably a connected reader that can read the RFID tags applied to the specimens. The PC receives the information read from the tags and associates each tag, via user input on the PC, with a patient and the appropriate collection data, such as date, time, type of specimen, etc. The printed label can be produced from the PC. At the collection site the range of a series of readers can be variable, in order to allow for specific zones to be read at one time so that the user can locate a specimen within a certain area. The collection site has a storage area for specimens awaiting pickup. Ordinarily the specimens must be transported to a different location, to a laboratory for analysis and testing. A courier picks up specimens at periodic intervals for transportation to the processing lab. A preferred feature of the invention is that the courier carries a hand-held device that connects, preferably wirelessly, to the collection site PC and database to inquire as to which specimens are to be picked up and the relevant data associated with each specimen.

Alternatively, in a situation where the collection site has no RFID reader, the courier can have a hand-held device that reads the specimens in the storage area to store this information in a data storage in the hand-held. In either event, the courier's hand-held device acquires the data for the specimens, and the courier physically takes the specimens and transports them to the lab for processing.

Once the courier has the specimens, the hand-held device (if capable of doing so) keeps track of all specimens to determine if any have left the possession of the courier. If a specimen goes out of the reader field, the hand-held device notifies the courier of this event and the courier can then use the device to find the specimen. In one preferred embodiment the courier's container carries its own RFID tag. After the courier obtains the data in his hand-held device regarding all specimen vessel RFID tags to be transported, the hand-held device can be used to download this information to the container's RFID tag. Thus, the container's RFID tag carries a list of all specimen vessels by RFID that are being placed in the container.

At the laboratory, the courier delivers the container with the specimens. In one preferred embodiment, the container carries an RFID tag that, when interrogated, indicates temperature within the container and will signify whether temperature within the container (or within any section of the container) has exceeded preselected allowable limits during transport. This will tell laboratory personnel whether the specimens are invalid and must be re-collected, or this can be determined by the courier during transit, if the courier's hand-held device has an RFID reader. A visible or audible alarm can be included if desired. The container's RFID tag can be coupled to a reader device on the container that reads the tag and then provides the visible or audible alarm.

On arrival at the laboratory, the courier, or laboratory personnel, use the hand-held device to connect to a computer and database in the laboratory, preferably wirelessly, and to download the specimen data from the hand-held's data storage to the lab database. This tells the system that the specimens have arrived at the lab and provides the system with a list of all specimens that are supposed to be present.

The specimens are then unpacked from the courier's container and their RFID tags are read, into the system's database. This confirms that the specimens actually present match the list that was downloaded into the system from the hand-held device. Once all specimens have been verified, the laboratory system starts to track the specimens.

In the laboratory, each specimen is tracked as needed. Multiple readers in the laboratory can be set to constantly read and report specimen location by determining the time of arrival for each read'tag (which will give triangulation information) and the power node which powered the tag (nodes operating at different times, e.g. in sequence). The reader antennas can be in a fixed position, or they can be rotating around directionally to read selectively certain areas. The system can employ time delay of arrival (TDOA) of the responsive signals, or a receive signal strength indicator (RSSI), or both, as well as variable power-up power (as from differently located nodes) to determine the distance from the reader emitting the power beam. Multiple antennas can form a beam that can be targeted to specific regions. There can be multiple antenna arrays of this nature with the controller for these arrays sending beam location back to the reader. Further, a person with a hand-held reader also can walk around the laboratory to find a specific specimen. The user is prompted on which way to proceed via the hand-held's data link back to the reader or tracking software. Any particular specimen is easily located among hundreds or even thousands of specimens in the laboratory using this system. A feature of the invention is that the hand-held device can have a power node for powering the passive RFID tags, from a close range of normally a few inches. The specimens are within range of a reader in the laboratory or other storage facility. With the hand-held the user turns on the power node to power a selected one or a small group of specimen tags causing them to be read by the reader. This enables verification or location of individual specimens when desired.

As in U.S. Pat. No. 7,317,378, the communication protocol of the system of the invention embraces two separate frequencies or frequency bands. Power signals from readers or nodes are on one frequency and responsive transmissions from the positive tags (and from active tags, if included) are on a separate frequency. This minimizes interference as noted in the patent.

It is among the objects of the invention to greatly improve on tracking, inventorying and auditing the location and movement of patient specimen samples using RFID tags; to reduce the number of data entry steps required; and to reduce or eliminate manual data entry. These and other objects, advantages and features of the invention will be apparent from the following description of a preferred embodiment, considered along with the accompanying drawings.

### DESCRIPTION OF THE DRAWINGS

FIG. 1 is a schematic system drawing showing a preferred embodiment of the specimen monitoring system of the invention.

FIG. 2 is a schematic drawing indicating a laboratory with a series of different readers for finding and keeping track of specimens, in accordance with one embodiment of the invention.

FIG. 3 is a schematic view indicating a transportable specimen container that assists in the tracking of specimens according to the invention.

FIG. 4 is a schematic view showing one use of a hand-held device of the invention.

### DESCRIPTION OF PREFERRED EMBODIMENTS

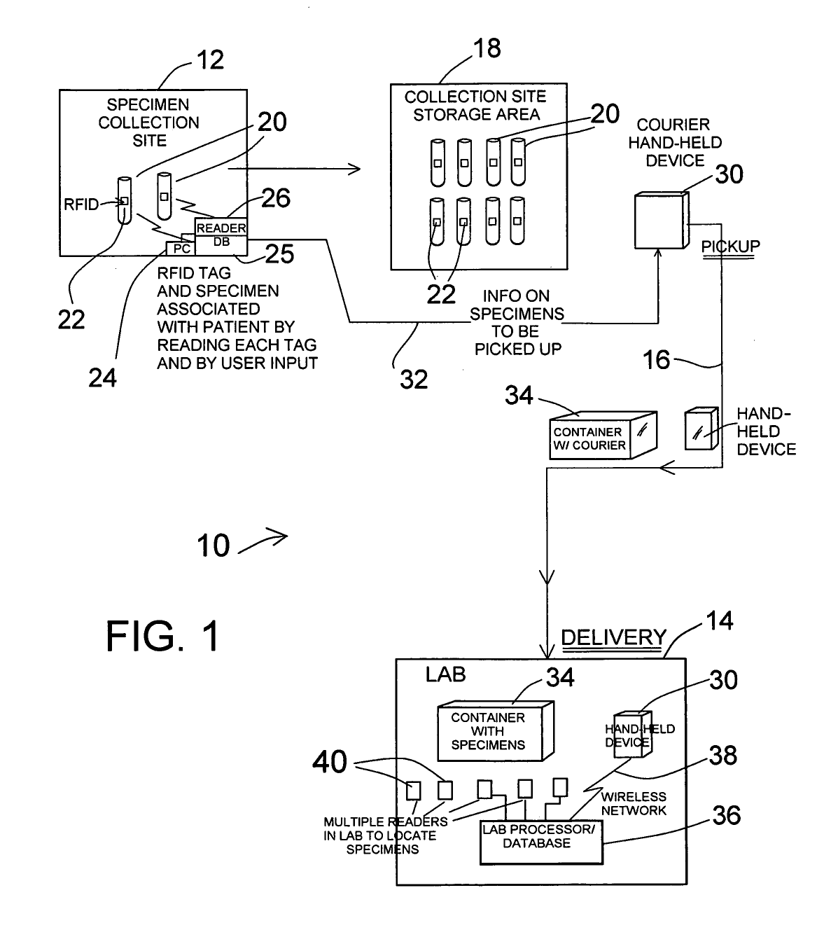

In the drawings, FIG. 1 shows schematically a specimen tracking system 10 which includes a specimen collection site 12 and a specimen testing laboratory 14 normally (but not necessarily) located remotely from the collection site. A transportation path from the collection site 12 to the laboratory 14 is shown at 16.

At the specimen collection site 12 a storage area 18 is included. Patient samples, such as blood, are collected in vessels 20, which can be the typical small tubes used for such purposes. Specimens are collected and placed in the collection site storage area 18, as indicated in this schematic illustration.

Pursuant to the invention a small RFID tag at 22 is secured to each specimen collection vessel 20. Immediately after each specimen is taken and enclosed in the vessel, the patient information for this particular specimen is associated with the RFID tag 22 on the vessel. For example, this may be done using a personal computer (PC) 24 at the collection site, which has a database 25 and an associated input device (not shown) such as a keyboard or keypad. An RFID reader 26 connected to the PC (by wire or wirelessly) reads the RFID tag 22. For the purposes of the invention the reader has a receiving range from the tags of at least about one meter. In the computer's database, the read RFID tag code is associated with the appropriate patient information (this can include patient name, address, other personal information, date, name/location of facility, nature of testing, etc.). Although the RFID tags 22 themselves in this preferred embodiment do not include any of the patient information, that information is embedded with the particular RFID tag code in the database, which, as will be seen, is preferably stored in several places and will be delivered to the laboratory 14.

In the most common situation the laboratory 14 is at a location remote from the specimen collection site 12. A courier typically carries a series of specimens to the lab, and the invention provides safeguards against loss, misplacing or mis-identification of specimens. In this system the courier carries a hand-held device 30 which has wireless receiving and transmitting capability and a database for storing information. All information on the series of specimens for a typical group to be transported to the lab is contained in the database 25 connected to the PC 24. This file of information is communicated to the hand-held device 30, preferably wirelessly but optionally by wired connection. The communication link is indicated at 32 in the drawing. In a preferred embodiment the hand-held unit 30 does not include an RFID reader, although it could include a reader if desired, such as to provide a further means of verifying the presence and identity of all specimens at any time during pickup, transport or delivery, or in a situation where a small collection site has no reader.

As noted above, the RFID tags 22 preferably are miniaturized tags, which have dimensions less than a few millimeters, and no greater than about ½ millimeter in thickness. These tags are secured directly onto the specimen vessels, e.g. blood tubes, in a manner that is essentially permanent. A strong glue can be used. The facility may optionally, but not necessarily, also place on each vessel a printed label carrying the name of the patient and other data relative to the collection of the specimen. This information normally will already have been typed into a PC pursuant to the sample to be taken, and a small label can be produced from the PC with the information and secured to the vessel.

Note that at the collection site 12, and especially in the collection site storage area 18, a series of RFID readers can be provided, particularly for the case of a large number of specimen vessels. As noted above, the range of each of the series of readers can be variable in order to allow for specific zones within the storage area to be read at one time, excluding the remainder, enabling a user to locate a specimen or specimens within a certain area.

The courier picks up the series of specimens in a container 34 provided for that purpose, and transports the container, along with the hand-held device 30, to the laboratory 14. The path from the collection site to the lab is shown at 16.

At the laboratory 14, the courier delivers the container carrying the specimens, as noted at 34. The hand-held device 30 is used to transmit the information to a lab regarding what specimens (with associated patient data) are being delivered. Again, this can be a wireless connected to a laboratory processor and connected database 36, as indicated at 38, or a wired connection can be used. In either event the laboratory database 36 acquires all information regarding the specimens that are supposedly being delivered. To verify this information, the lab has one or preferably a series of RFID readers 40, positioned to read the RFID tags of the specimen vessels in the container or as unloaded from the container, or after unloading.

This reader or readers 40 are connected to the lab processor/database 36, as indicated schematically. A comparison is made in the processor/database 36, to verify whether or not the downloaded list of specimens matches the list of RFID tags actually read from the delivered specimens.

Tracking of specimens is important in the laboratory, and the invention provides a very secure system for verifying, properly identifying and locating specimens. The multiple readers 40 preferably are provided because the laboratory will usually have a multiplicity of specimens at any one time, usually stored in different zones. Tracking of specimens using the readers in different ways is described above. As noted there, any particular specimen can easily be located from hundreds or thousands of specimens in the laboratory using the system of the invention.

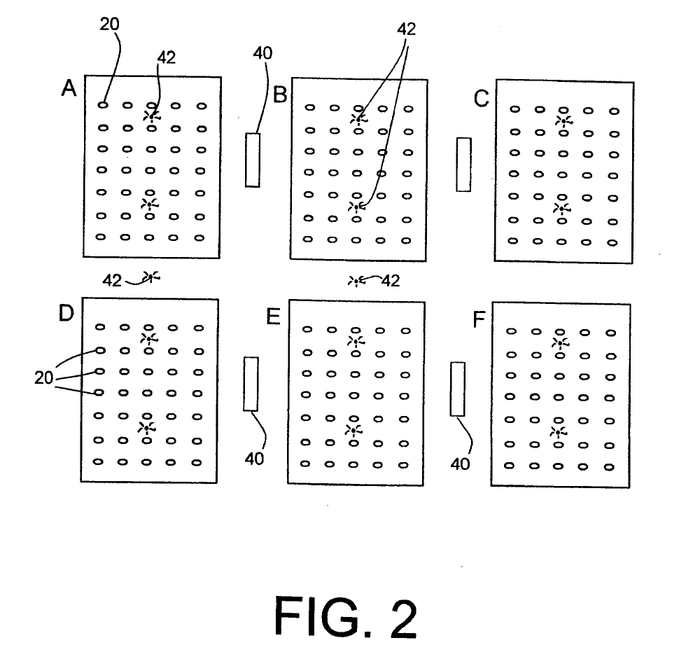

FIG. 2 schematically shows a laboratory storage area with a series of RFID readers 40 located for finding and keeping track of a large number of specimens 20. The specimens are shown as contained in a series of different zones identified in this example as zones A through F. The zones can be spaced apart to a greater extent than illustrated in FIG. 2, in order to isolate the location of a group of specimens, based on which reader 40 is able to read particular specimens. Alternatively, the readers 40, or some of them, can be without power nodes (or with selectively powered nodes), and power nodes can be located at particular, strategic locations (which may be many, as shown at 42), further isolating the group of specimens that are powered at any given time and thus enabling identification of a location from which a specimen's signal is taken.

FIG. 4 is a schematic view indicating another feature of the invention described above. The hand-held device 30a, even if not including a reader itself, can be provided with a power node 30b for powering the passive RFID tags 22. The range of the power node preferably is up to about 12 inches or so, but one important feature is that the range is settable by the operator. For example, for powering one or a small group of tags the node's power range can be set to a close range which would normally be just a few inches, usually about two inches to three inches. The short range enables discrimination in which specimen tags are powered, and the power node is preferably directional as well, allowing the operator to direct the power specifically. An RFID reader 40 is assumed to be within range of all specimens. As noted above, with the hand-held device 30a a user in the laboratory turns on the power node (with a switch 30c) and adjusts the power range, to power a selected one or a small group of specimen tags 22 on specimens 20, causing them to be read by a reader 40 nearby. With this locally selected powering of one or more tags the user can verify the identity of any particular specimen, or locate individual specimens as desired.

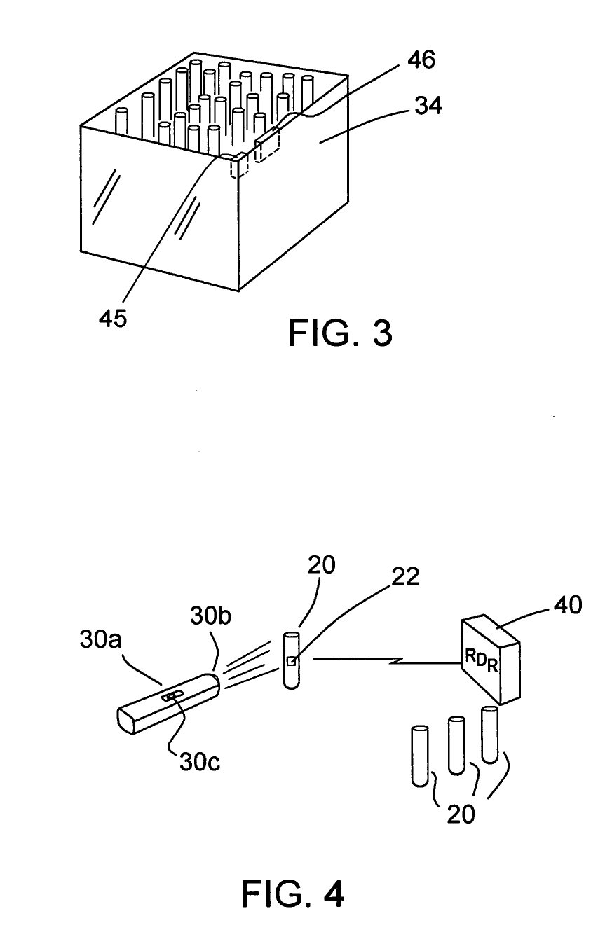

FIG. 3 indicates schematically a preferred embodiment of a specimen container 34. As described above, this container (normally a cooler) can have certain capabilities beyond simply holding the specimens for transport. The container 34 can have its own RFID tag 45 which can be interrogated to indicate temperature within the container. This is typically an active RFID tag, with battery. More importantly, the RFID tag 45 can have a deep memory. It can record, for example, the highest temperature reached in the container (or a segment of the container, if several such tags 45 are included) during transport. The tag circuitry can include a temperature function which, when the tag is interrogated, will indicate a maximum temperature that has been reached. When the container 34 reaches the lab, this container RFID tag 45 is interrogated by a reader 40, and if the temperature has been outside permissible limits, the specimens are invalid and must be retaken.

Another function of the container is that the container may have its own reader 46, positioned to read the tags within the container and thus to establish a running audit to keep track of the specimens as they are transported. The read information is stored within the reader to be read once the container is within the laboratory. Alternatively, if the container does not have a reader, an external reader can be used to read all specimens in the container and to put the specimen data into deep memory of the RFID tag 45 by communicating directly to the RFID tag, via the RFID tags communications protocol, on the container once all specimen's have been read.

The system of the invention, at the laboratory and possibly also at the point of collection, as well as on the transportable container as discussed above, can have active RFID tags as well as passive RFID tags. Active tags have battery power; passive tags in this invention receive power from an RF signal from a reader or power node. On the sample tubes, space and cost concerns will typically require that the attached tags be small in size and passive. As noted above, the transportation container can have one or several active RFID tags and can monitor temperature or other conditions. At the laboratory and/or at the point of collection, there may be active tags, for example, on one or more carts that can carry multiple containers of samples; or an active tag could be on a platform or table or desk that may sometimes hold samples, for example. In addition, one or more stationary power nodes could carry an active RFID tag, with the active tag used to identify the power node which has been activated during a procedure for locating one or more specimens or inventorying specimens. Alternatively, a node can be identified simply by knowledge of which node is being activated at any particular time. In the invention the active tags preferably use the same communications protocol as the passive tags so that a reader can read both types of tags.

Note that the above procedure can be supplemented or modified by another form of transmission of the data on all samples and patients (including RFID data), such as by a computer link (e.g. phone line or Internet) transmitting between the collection site PC 24 and the laboratory processor/database 36. If this is done, the hand-held device can still be used to double check that all read samples have been picked up and properly processed.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. A method for tracking patient specimens using RFID tags, readers and hand-held devices, comprising:
placing an RFID tag on a specimen vessel at a point of collection for patient specimens, the RFID tag being passive and having a transmit range of at least about one meter,
associating the specimen vessel via the RFID tag with a patient the specimen is taken from, in a database, including reading the RFID tag via an RFID reader and inputting the read data from the tag into the database along with information identifying the patient,
assembling a plurality of such specimen vessels, and using a hand-held device that includes a data storage and a link to said database, sending data from the database to the hand-held device,
delivering the specimen vessels in a container to a laboratory, accompanied by the hand-held device with data storage, and
at the laboratory, reading the RFID tags of all specimen vessels from the container and downloading data from the data storage to a laboratory processor/database, and verifying that all specimens listed in the data storage have arrived and are present.

2. The method of claim 1, further including tracking and locating the plurality of specimens at multiple times at the laboratory during testing and storage of the specimens.

3. The method of claim 2, further including tracking and locating each specimen through disposal of the specimen.

4. The method of claim 1, wherein the container carries an RFID tag, and the method including, following reading all of the RFID tags from the plurality of specimens, downloading to the container's RFID tag a list of all specimen vessels that are being placed in the container.

5. The method of claim 1, wherein the link between the hand-held device and said database is wireless.

6. The method of claim 1, wherein the step of downloading data at the laboratory is wireless.

7. The method of claim 1, wherein the container carries an RFID tag capable of reading temperature of one or more sections within the container and that, when interrogated, indicates the present temperature within the container.

8. The method of claim 7, wherein the temperature-indicating RFID tag includes a visible or audible indicator to signify when container temperature, or temperature of a section of the container, has been outside preselected allowed limits.

9. The method of clam 6, wherein the temperature-indicating RFID tag is an active tag with a battery.

10. The method of claim 1, wherein RFID readers at the point of collection and at the laboratory are capable of reading both active and passive RFID tags.

11. The method of claim 1, wherein the hand-held device includes an RFID reader, and including using the hand-held device to read and store in the data storage data from RFID tags of the plurality of specimens while the specimens are at the point of collection.

12. The method of claim 1, wherein both active RFID tags and passive RFID tags are present at the point of collection or at the laboratory, and wherein RFID readers at the point of collection or the laboratory are capable of reading both active and passive RFID tags, both of which share a common communication protocol.

13. The method of claim 12, wherein both active RFID tags and passive RFID tags are present at the laboratory, and including locating RFID tags by time delay of arrival (TDOA) of tag data at a reader or receive signal strength indication (RSSI) of RFID tag signals received at a reader, or both.

14. The method of claim 1 wherein, at least at the laboratory, a plurality of power nodes are positioned to power RFID tags of the specimen vessels in respective locations, and including the step of locating RFID tags by proximity to a power node known to be active at the time of interrogation by a reader.

15. The method of claim 1, wherein the point of collection or the laboratory includes both active RFID tags and passive RFID tags, and including locating both active and passive RFID tags by time delay of arrival (TDOA) of tag data at a reader, or by receive signal strength indication (RSSI) of both active and passive tag signals received at a reader, or both.

16. The method of claim 1, wherein the hand-held device includes a power node selectively operable to emit locally a powering signal to power passive RFID tags within a close distance of the power node, and the method including, with a reader within reading range of a collection of specimen vessels with passive RFID tags, using the hand-held device to power only selected ones of the collection of RFID tags so as to identify one or a small cluster of specimen vessels.

17. The method of claim 16, wherein the power node's powering signal is settable to a close distance of approximately two inches, and wherein the power node is directional.

18. A method for tracking patient specimens using RFID tags, readers and hand-held devices, comprising:
placing an RFID tag on a specimen vessel at a point of collection for patient specimens,
associating the specimen vessel via the RFID tag with a patient the specimen is taken from, in a database, including reading the RFID tag via an RFID reader and inputting the read data identifying the tag into the database along with information identifying the patient,
assembling a plurality of such specimen vessels, and transferring data from all read tags to a data storage in a hand-held device,
delivering the specimen vessels in a container to a laboratory, accompanied by the hand-held device,
at the laboratory, reading the RFID tags of all specimen vessels from the container and downloading data from the data storage of the hand-held device to a laboratory processor/database, and verifying that all specimens listed in the data storage have arrived and are present, and
at the laboratory, locating specimen vessels via a series of power nodes placed at different locations among the specimen vessels, and one or more RFID readers near the specimen vessels, each power node having limited range, by selectively activating power nodes to isolate the location from which one or more responding signals are received at a reader or readers.

19. The method of claim 18, further including, at the laboratory, utilizing a hand-held device having a power node that is selectively activated by the user, the range of the hand-held device's power node being settable to no more than about a few inches, and including using the hand-held device with the power node to power up passive RFID tags on one or a small group of RFID tags on specimen vessels and reading the responses at one or more RFID readers so as to identify the one or small group of RFID tags of specimen vessels.

20. The method of claim 18, wherein the RFID readers and the RFID tags operate on two separate frequencies, a first frequency received by the RFID tags to power the passive RFID tags, and a second frequency for transmission by the RFID tags to the readers.
